(19) United States
(12) Patent Application Publication
(10) Pub. No.: US 2008/0076621 A1
(43) Pub. Date: Mar. 27, 2008

(54) Door Closer

(75) Inventor: Volker Bienek, Dortmund (DE)

Correspondence Address: COHEN, PONTANI, LIEBERMAN & PAVANE, 551 FIFTH AVENUE, SUITE 1210, NEW YORK, NY, 10176, US

(73) Assignee: DORMA GMBH + CO. KG, ENNEPETAL (DE)

(21) Appl. No.: 11/793,258

(22) PCT Filed: Nov. 11, 2005
(86) PCT No.: PCT/EP05/12090

§ 371 Date: Jun. 18, 2007

(30) Foreign Application Priority Data
Dec. 17, 2004 (DE) 10 2004 061 627.2

(51) Int. Cl. F16H 13/10

(52) U.S. Cl. 476/65

(57) ABSTRACT

A door closer includes a housing; an output shaft supported by the housing and rotatable in opposite door opening and closing directions; a cam disc disposed in the housing and mounted on the output shaft; a damping piston disposed in the housing; an opening piston disposed in the housing; first and second force transmission rollers; and two fixing bolts extending in the axial direction of the housing and transversely to the axis of the output shaft. The fixing bolts being disposed on two opposite sides of the output shaft, respectively. Each of the can disc and the first and second force transmission rollers has a circumferential recess or comprises two pieces, the fixing bolts being disposed in the recesses or between the respective two pieces so that each of the damping piston and the opening piston is prevented from rotating with respect to the cam disc.

The invention relates to a door closer according to the generic part of patent claim 1, which has an output shaft, which can be actuated in the closing direction by an assembly of springs, and has a damping piston, which is in operable connection with the shaft, as well as a pivotable actuating arm, which is coupled to the output shaft outside the housing, as well as a cam disc, which is connected to the output shaft inside the housing.

A door closer of the species mentioned at the beginning is revealed in DE 40 41 824 C1, in which a rotation of the damping piston and of the opening piston about their longitudinal axes in relation to the cam disc is eliminated. Securing means, which prevent the rotation, are provided for this purpose. The proper functioning of the door closer is not at all affected by the incorporation of the securing means. The first choice of securing means are two rods, which, on the one hand, are firmly anchored in the spring support member and, on the other hand, can plunge, without any friction on the opposite side, into pocket bores of the damping piston. In this case, the securing rods extend horizontally to the axis of the closer shaft. The securing rods are disposed on either side close to the closer shaft in the axial direction of the housing. It is thus possible that, in the event of a rotation of the damping piston or of the spring support member, the securing rods either bear against the one or the other side of the closer shaft.

The object of the invention is to further develop the anti-rotation means of the state of the art in that a clearance-free contact is given at all times between the force transmission rollers and the damping piston or the opening piston. Furthermore, it is intended to improve the efficiency of the door closer.

This problem is solved with the features of patent claim 1. In this context, the dependent claims represent another embodiment of the inventive idea.

The state of the art is improved in that, for the purpose of increasing the efficiency, the cam disc and the force transmission rollers respectively have a circumferential recess or a groove, which is dimensionally adapted such that fixing bolts of the known type can be supported therein with minor play. Embedding the fixing bolts on the one hand allows for a smaller structure of the door closer and moreover for a reliable mounting of such a door closer. For this purpose, the fixing bolts, which respectively have their ends threaded, are firmly screwed into the opening piston with one of their ends. Obviously, other connecting types are possible. For mounting the damping piston, the free ends of the screwed-in fixing bolts can plunge into the damping piston and can be secured therein by appropriate nuts, which are preferably provided in a stepped bore of the damping piston. In order to guarantee a precisely fixed position between the force transmission rollers and the cam disc, a spring element is placed between a bottom of the stepped bore and the nut. The spring element may be either a disc spring or any other suitable spring element. By means of such a spring element, the elasticity of the overall construction is increased, in particular during the rotation of the output shaft. Likewise, respective tolerances of the cam disc and of the force transmission rollers can be easily compensated for. However, a clearance-free contact is guaranteed at the same time between the force transmission rollers and the cam disc.

The circumferential groove in the rollers and the recess in the cam disc are preferably disposed in the area of the longitudinal axis of the cylinder bore. Such a disposition is able to transmit tension and compression forces without entailing any deformation of the fixing bolts. Thus, there is no height offset and therefore no bending moment will occur.

One the one hand, the clearance-free contact increases the operational safety and thus the efficiency and, on the other hand, such a door closer achieves a very good arresting function. Even in the event of reversals of the output shaft, the contact between the force transmission rollers and the cam disc is maintained permanently. For this purpose, the force transmission rollers are rotatably supported via bearing journals, which plunge into pocket bores provided within the opening piston and the damping piston. In order to prevent the bearing journals from sliding out of the pocket bores, they are protected from falling out by means of appropriate securing pins.

On account of the clearance-free contact, an optimal arresting function can be achieved of such a door closer while increasing the efficiency at the same time.

Hereinafter, the invention will be explained based on one possible exemplary embodiment diagrammatically illustrated in the drawings, wherein:

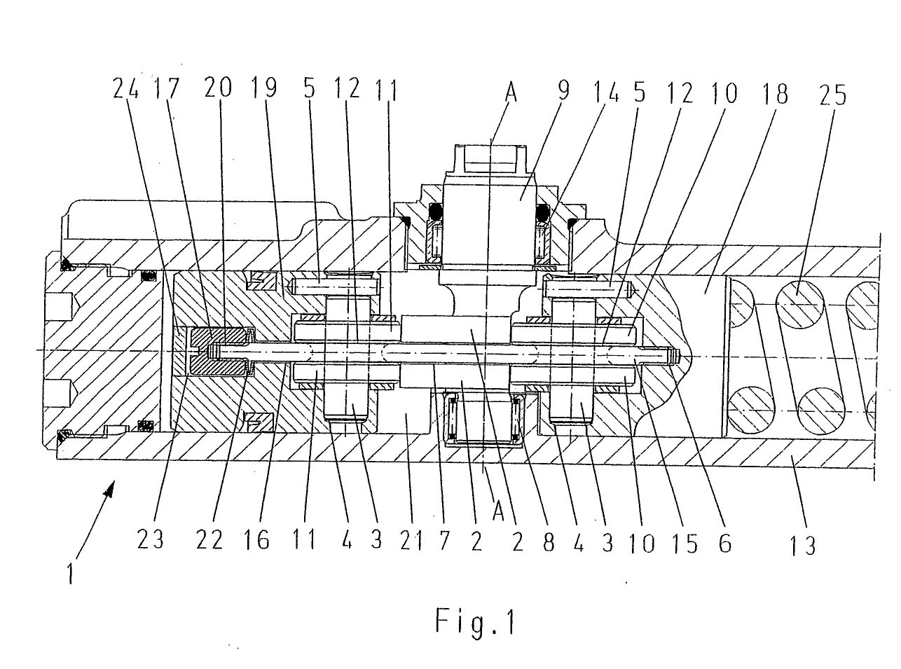

FIG. 1 shows a partial view of a door closer in a longitudinal cut according to the axis of the housing; and

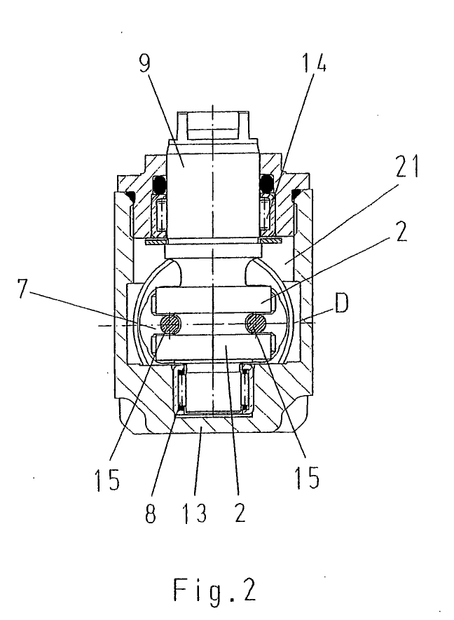

FIG. 2 shows the same as FIG. 1, however in a cross-section according to the line A-A through the output shaft.

FIG. 1 shows a door closer indicated at 1 in a partial view, in which the components, which are not relevant for the invention, have been omitted or are not identified by a reference numeral. An output shaft 9 is supported in a bearing 8 within a housing 13 such that, at the exit side, the shaft 9 is connected to the housing 13 by means of a screwed cap with a bearing 14. The output shaft 9 has a cam disc 2, which has a circumferential groove 7 (see in particular FIG. 2).

A damping piston 19 and an opening piston 18 are displaceably supported within the closer housing 13 on the left and right sides of the cam disc 2. A spring 25, in the shape of a force accumulator, presses against the opening piston 18. Force transmission rollers 10 and 11 respectively are rotatably supported in both, the opening piston 18 and the damping piston 19 by means of bearing journals 3. In this case, the bearing journals 3 plunge into pocket bores 4. In order to prevent the bearing journals 3 from sliding out, they are secured by means of appropriate securing pins 5.

Within the force transmission rollers 10, 11 a circumferential groove 12 is respectively provided, like in the cam disc 2; it is also possible to execute the force transmission rollers 10, 11 and the cam disc in two pieces.

Referring to the opening piston 18, FIG. 1 represents a fixing bolt 15, which has threads 6 and 20 respectively at its ends. In this case, the thread 6 is screwed into a threaded bore in the opening piston 18. The dimensions of the fixing bolts 15 are adapted such as to be embedded with very little clearance within the groove of the force transmission rollers 10, 11 and within the groove 7 of the cam disc 2 as well.

The other end of the fixing bolts 15 with the thread 20 passes respectively through a bore 16 within the damping piston 19 and ends in a stepped bore 23 within the damping piston 19. A nut 17, which pulls the fixing bolt 15 on account of the thread 20 against a bottom of the stepped bore, is located in the stepped bore 23. In order to achieve a higher operational safety and tolerance compensation with regard to the force transmission rollers 10, 11 and the cam disc 9, a spring element 22, preferably in the shape of a disc spring, is introduced between the bottom of the stepped bore 23 and the nut 17. This achieves a permanent contact of the force transmission rollers 10, 11 and the cam disc 2.

In order to seal off this connection in the damping piston 19, the stepped bore 23 is closed by a seal washer 24.

FIG. 2 reveals that, on account of the stable position of the output shaft 9 through the internal bearings 8 and 14 and of the fixing bolts 15 embedded within the groove 7 of the cam disc 2, a rotation of the opening piston 18, displaceable within a reception compartment 21, and of the damping piston 19 about their own axes is not possible.

### LIST OF REFERENCES

1 door closer
2 cam disc
3 bearing journal
4 pocket bore
5 securing pin
6 thread
7 groove
8 bearing
9 output shaft
10 force transmission roller
11 force transmission roller
2 groove
13 housing
14 bearing
15 fixing bolts
16 bore
17 nut
18 opening piston
19 damping piston
20 thread
21 reception compartment
22 spring member
23 stepped bore
24 seal washer
25 spring

1.-9. (canceled)

10. A door closer comprising:
a housing having an axial direction;
an output shaft supported by the housing, the output shaft being coupleable to a door via a pivotable actuating arm and being rotatable about an axis in a door opening direction and an opposite door closing direction;
a cam disc disposed in the housing and mounted on the output shaft;
a damping piston disposed in the housing and having a first force transmission roller charged against a cam path associated with the closing direction for rotating the output shaft in the closing direction;
an opening piston disposed in the housing and having a second force transmission roller charged against a cam path associated with the opening direction for rotating the output shaft in the opening direction; and
two fixing bolts extending in the axial direction of the housing and transversely to the axis of the output shaft and coupling the damping piston to the opening piston, the fixing bolts being disposed on two opposite sides of the output shaft,
wherein each of the can disc and the first and second force transmission rollers has a circumferential recess or comprises two pieces, the fixing bolts being disposed in the recesses or between the respective two pieces so that each of the damping piston and the opening piston is prevented from rotating with respect to the cam disc.

11. The door closer of claim 10, wherein the housing defines a reception compartment for accommodating the opening piston and the damping piston, the reception compartment having a central axis, along which the fixing bolts extend.

12. The door closer of claim 10, wherein each fixing bolt has opposite first and second threaded ends.

13. The door closer of claim 12, wherein the opening piston has two threaded bores, the second threaded ends of the fixing bolts being threaded into the respective threaded bores of the opening piston.

14. The door closer of claim 13, further comprising two nuts which are disposed in the damping piston and threaded on the respective first threaded ends of the fixing bolts so that the damping piston together with the first force transmission roller is pulled against the cam disc, and the opening piston together with the second force transmission roller is pulled against the cam disc.

15. The door closer of claim 14, wherein the damping piston has two stepped bores, the nuts being embedded in the respective stepped bores of the damping piston.

16. The door closer of claim 15, further comprising two springs, each spring being respectively disposed between one of the nuts and a bottom of the respective stepped bore.

17. The door closer of claim 16, wherein each spring comprises a disc spring.

18. The door closer of claim 10, further comprising two securing pins and two bearing journals which are secured in the damping piston and the closing piston, respectively, by the securing pins, the first and second force transmission rollers being rotatably supported by the respective bearing journals.
